(19) United States
(12) Patent Application Publication
(10) Pub. No.: US 2026/0364820 A1
(43) Pub. Date: Nov. 19, 2026

(54) Robotic Hand

(71) Applicant: Human Mode, LLC, Oklahoma City, OK (US)

(72) Inventors: Jonathan Gilmore, Oklahoma City, OK (US); Bao Do, Oklahoma City, OK (US)

(73) Assignee: Human Mode, LLC, Oklahoma City, OK (US)

(21) Appl. No.: 19/148,312

(22) PCT Filed: Jan. 16, 2024
(86) PCT No.: PCT/US2024/011672

§ 371 Date: Jul. 15, 2025

Related U.S. Application Data
(60) Provisional application No. 63/439,177, filed on Jan. 16, 2023.

(51) Int. Cl. B25J 15/02; B25J 9/12

(52) U.S. Cl. CPC B25J 15/026; B25J 9/126

(57) ABSTRACT

A mechanical hand is provided for use in grasping an object. In some embodiments, the hand has a base; a motor; a plurality of interlocking gears attached to the base, each gear having an individual axis of rotation; and a plurality of fingers, wherein each finger is attached to a corresponding gear. In other embodiments, the hand includes a base; a plurality of cams attached to the base, each cam having an individual axis of rotation; a plurality of motors, where each motor is configured to power one corresponding cam; and a plurality of fingers, wherein each finger is attached to a corresponding cam. In another aspect, a robot is provided for use in gripping and moving an object. In some embodiments, the robot has a body; a plurality' of sensors integrated into the body; a control system; an arm; and a hand. In several embodiments, the robot has a hand according to the first set of embodiments above, utilizing a plurality of interlocking gears. In other embodiments, the robot includes a hand according to the second set of embodiments above, utilizing a plurality' of cams.

### RELATED APPLICATIONS

This application claims the benefit of U.S. Provisional Patent Application Ser. No. 63/439,177 filed Jan. 16, 2023 entitled “Robot Hand,” the disclosure of which is herein incorporated by reference as if fully set forth herein.

### FIELD OF THE INVENTION

This invention relates generally to the field of robotics and more particularly, but not by way of limitation, to a robotic hand.

### BACKGROUND

Robots are employed in a variety of fields for commercial, research, military, and other purposes. In recent years, industries such as manufacturing and commercial food processing have increasingly relied upon robotic mechanisms to automate processes with greater precision and speed than is possible by human workers alone.

In some applications, the field of robotics has provided mechanisms for grasping and moving objects, either based on the real-time instructions of a manual operator or based upon pre-set programming. Some existing robots employ a clamp claw with fingers that use a pinching action to engage and pick up objects. Other robots use jointed appendages to wrap around an object and create an encompassing grip thereon.

The existing robotics mechanisms for grasping and moving objects are complicated and limited in their ability to adjust grip for objects of varying size and shapes. In many applications, the grips of these existing mechanisms must be altered through manual adjustment before the mechanism can be employed. For example, with a clamp claw, the distance of the claw fingers from a central point may need to be manually adjusted to permit the claw fingers to securely grasp objects of larger or smaller sizes. These manual adjustments can be time-intensive, costly, and unwieldy for operators. There exists a need, therefore, for a robotic grasping mechanism that can securely grasp objects of varying sizes and shapes without the need for time-and cost-intensive manual adjustments to the mechanism.

### BRIEF DESCRIPTION OF THE DRAWINGS

FIG. 1 depicts a mobile robot with a mechanical hand supported by an articulating arm.

FIG. 2 depicts a stationary robot with a with a mechanical hand supported by an articulating arm.

FIGS. 3-4 provide first and second perspective views of the mechanical hand constructed in accordance with a first embodiment.

FIG. 5 provides a depiction of the carrier gears and fingers of the mechanical hand of FIGS. 3 and 4.

FIGS. 6-7 depict the approximation of the fingers of the mechanical hand of FIGS. 3-5 around an object.

FIGS. 8-9 provide first and second perspective views of the mechanical hand constructed in accordance with a second embodiment.

FIGS. 10-11 depict the approximation of the fingers of the mechanical hand of FIGS. 8-9 around an object.

### WRITTEN DESCRIPTION

While this invention is susceptible to embodiment in many different forms, there are shown in the drawings and will herein be described in detail some specific embodiments of the invention. It should be understood, however, that the present disclosure is to be considered an exemplification of the principles of the invention and is not intended to limit the invention to the specific embodiments so described.

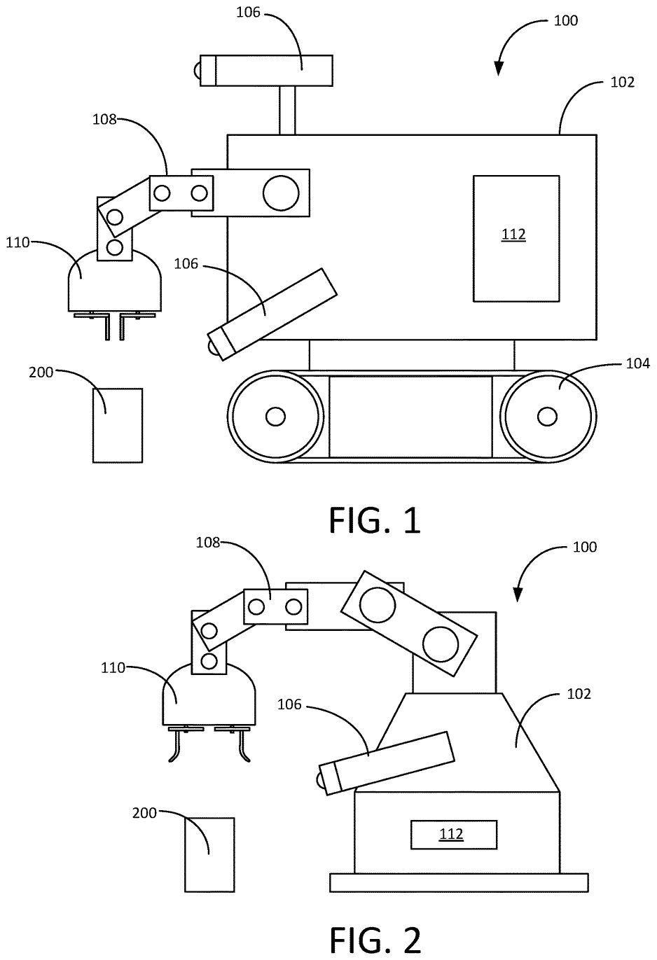

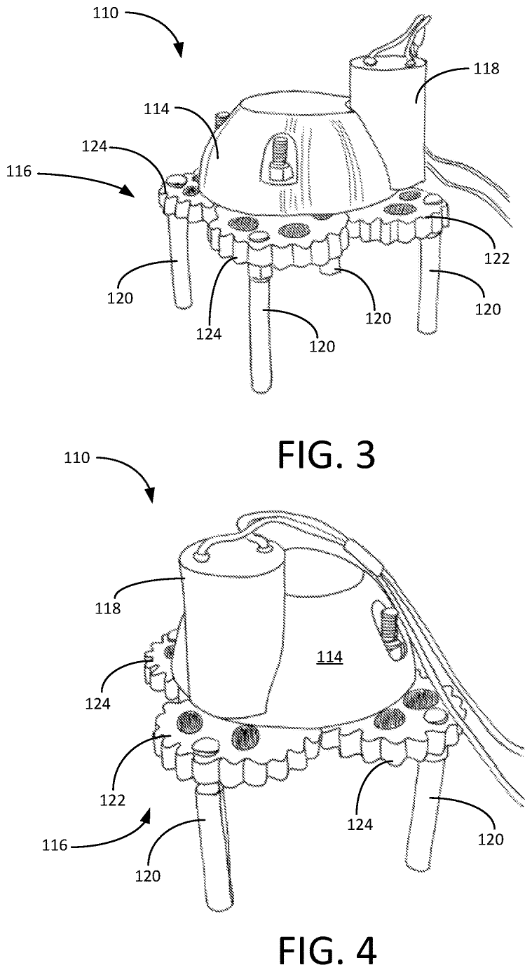

Referring now to the figures of the drawings, wherein like numerals of reference designate like elements throughout the several views, and initially to FIG. 1, a robot 100 is depicted in accordance with an exemplary embodiment. The robot 100 includes a body 102 and a mobility system 104 attached to or integrated with the body 102 to permit the robot 100 to move from one location to another. The mobility system 104 may employ a track system (as shown), wheels, legs, propellers, or other mobility mechanisms. In the embodiment depicted in FIG. 2, the robot 100 operates from a stationary position (e.g., in an assembly line) and does not include the mobility system 104. In each case, the robot 100 further includes a plurality of sensors 106 which may include navigational and positioning sensors, velocity sensors, acceleration sensors, motor torque sensors, cameras, light sensors, range sensors, sound sensors, proximity sensors, tactile sensors, and temperature sensors.

As illustrated in FIGS. 1 and 2, the robot 100 includes an arm 108 and a hand 110 supported by the arm 108. The arm 108 can include articulating, extensible and retractable joints that permit the arm 108 to position the hand 110 in an operative position to grasp an object 200. In some embodiments, the hand 110 can be affixed directly to the body 102 of the robot 100.

The robot 100 of FIG. 1 further includes an integrated electronic control system 112 which is configured to control the operation of the robot 100, including the mobility system 104 (if so equipped), the arms 108, and hands 110. For example, the control system 112 may control the speed and direction of movements made by the arms 108 and hands 110. In some embodiments, the control system 112 of the robot 100 is pre-programmed to execute one or more specific actions in response to input received from the sensors 106. As an example, visual input from camera sensors 106 can be used by the control system 112 to position the hand 110 directly over the object 200. In other embodiments, an operator may access the control system 112 locally or remotely to provide real-time instructions for the robot 100 to perform certain actions.

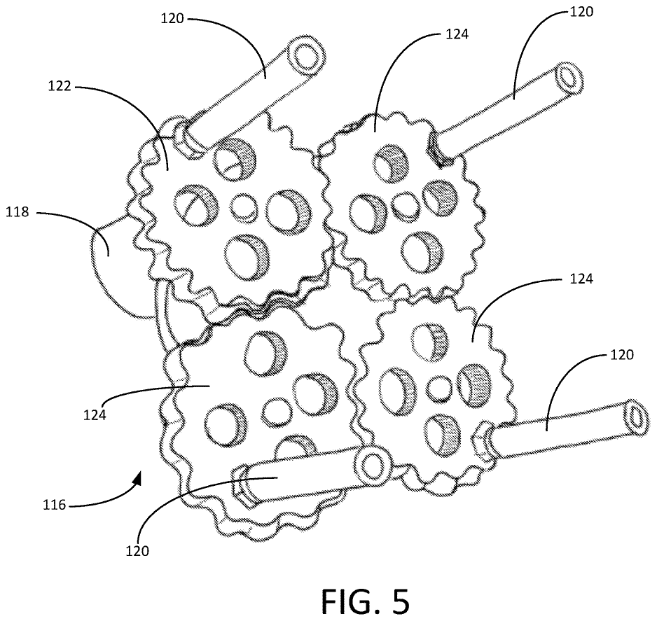

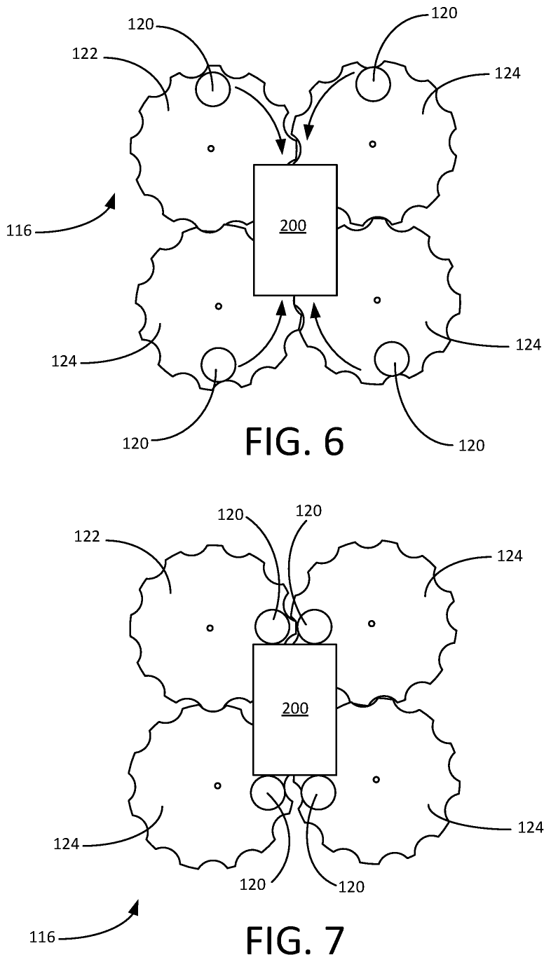

FIGS. 3-7 depict the hand 110 constructed in accordance with a first embodiment. The hand 110 includes a base 114, a plurality of rotary carrier elements 116, at least one drive motor 118, and a plurality of fingers 120. In the embodiment depicted in FIGS. 3-4, the rotary carrier elements 116 are configured as intermeshing gears, with one or more driven gears 122 and one or more passive gears 124. In FIGS. 3-5, a single drive motor 118 is connected to a single driven gear 124, which is intermeshed with one or more passive gears 124. In this way, the single drive motor 118 can impart rotary motion to each of the intermeshed passive gears 124 through the single driven gear 122. Although four rotary carrier elements 116 are depicted, it will be appreciated that fewer or greater numbers of rotary carrier elements 116 are contemplated within exemplary embodiments. For example, in some embodiments, the hand 110 can include 2, 3, 4, 5, 6, 7, 8, 9 and 10 rotary carrier elements 116 that are driven by one or more drive motors 118.

The drive motor 118 can be an electric motor that transfers torque to the corresponding driven gear 122 through a rotating motor shaft (not separately designated). In exemplary embodiments, the drive motor 118 is supported by the base 114. The drive motor 118 is configured to rotate the driven gear 122 in both directions at constant or variably controlled rotational speeds in response to a command signal from the control system 112. Although a single drive motor 118 is depicted in FIGS. 3-5, it will be appreciated that multiple drive motors 118 can also be used.

The fingers 120 extend away from the rotary carrier elements 116. In some embodiments, the fingers are connected directly to the driven and passive gears 122, 124. In other embodiments, the fingers 120 are connected to the rotary carrier element 116 with an intervening support between the finger 120 and the corresponding driven or passive gear 122, 124. In some embodiments, two or more fingers 120 are attached to a single rotary carrier element 116.

In exemplary embodiments, each finger 120 is configured as an elongated cylinder. It is appreciated, however, that the fingers 120 may be configured in a variety of other shapes. Fingers 120 of different lengths and widths may also be used with the hand 110. In most embodiments, each finger 120 is of the same size, length, and width. In other embodiments, the sizes, lengths, and widths of the fingers 120 are not uniformly the same. The hand 110 can include fingers 120 that are rigid or flexible, or a combination of rigid and flexible fingers 120. In some embodiments, one or more of the fingers 120 on the hand 110 are curved. In some embodiments, one or more of the fingers 120 includes an exterior coating, sleeve or layer that is rubberized or provided with another grippy material or surface preparation to increase the frictional contact between the fingers 120 and the object 200.

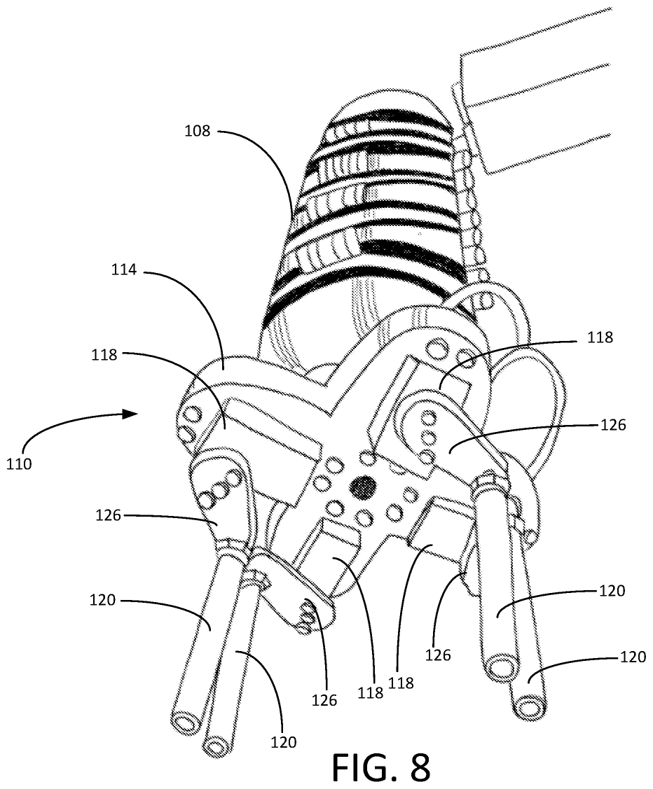

As best illustrated in FIGS. 6-7, In exemplary embodiments, each finger 120 is attached to its corresponding rotary carrier element 116 in a position that is radially offset from the center of rotation of the rotary carrier element 116. In this configuration, the rotation of each rotary carrier element 116 causes the corresponding finger 120 to move toward or away from the center of the hand 110.

In use, the hand 110 can be used to grasp and move the object 200. To do so, the hand 110 is first positioned a small distance from the object 200. The drive motor 118 has rotated the fingers 120 into an “open” position in which the fingers 120 are located at a spaced-apart distance from the object 200, as depicted in FIG. 6. The hand 100 is moved closer to the object 200 such that the object 200 is located within a grasping radius defined by the outer periphery of the fingers 120. In response to an appropriate command signal, the drive motor 118 then rotates the rotary carrier elements 116 to approximate the fingers 120 toward the object 200, as depicted in FIG. 7. In the embodiment depicted in FIGS. 6-7, the rotation of the driven gear 122 in a first direction causes the adjacent passive gears 124 to rotate in an opposite, second direction. The third passive gear 124 is intermeshed with at least one of the passive gears 124 intermeshed with the driven gear 122, which causes the third passive gear to rotate in the same direction as the driven gear 122. In this way, as the driven gear 122 turns, the intermeshed passive gears 124 turn either clockwise or counterclockwise based on their position relative to the active driven gear 122.

In FIG. 7, the fingers 120 have been rotated into contact with the object 200 and are applying a clamping force to the object 200 that is sufficient to lift, move, tilt, or rotate the object 200. The extent of the clamping force applied by the fingers 120 to the object 200 can be controlled by monitoring the electrical current (load) on the drive motor 118. In other embodiments, separate force sensors can be used to detect the extent of lateral force applied by the fingers 200 to the object 200. To release the grip of the hand 110 on the object 200, the motor 118 turns the driven gear 122 in a second direction, which is either clockwise or counterclockwise but is the opposite direction than was used when establishing the grip. This rotation causes the passive gears 124 to also turn in the direction opposite to what was used when establishing the grip. The rotation of the rotary carrier elements 116 causes the fingers 122 to move away from the object 120, thereby releasing the grasp of the hand 110 on the object 200.

In certain applications, the hand 110 is supported by the arm 108 in a manner that permits the hand 110 to self-center over the object 200 as the fingers 120 are approximated during a grasping action. If, for example, the hand 110 is not centered over the object 200 before the grasping action is initiated, some fingers 120 will arrive at the object 200 before other fingers 120. As the fingers 120 continue to rotate into a closed position around the object 200, the early contact by some of the fingers 120 will pull the hand 110 into a central alignment over the object 200. In this way, the rotational approximation of the fingers 120 provides a self-centering function that reduces the need to precisely align the hand 110 over the object 200. This presents a significant advantage over conventional pincher-type mechanisms that must be precisely aligned to ensure a successful grasping operation.

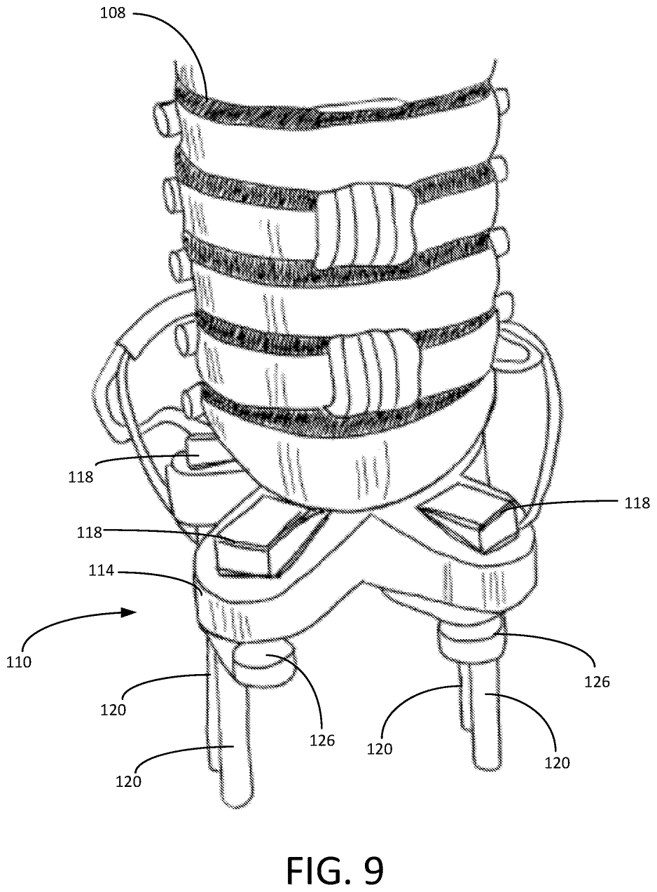

Turning to FIGS. 8-9, shown therein is a second embodiment of the hand 110. In this embodiment, the hand 110 includes a plurality of drive motors 118 mounted on the base 114. Each drive motor 118 is connected to a corresponding rotary carrier element 116, which can be configured as a rotatable cam member 126 that supports a corresponding finger 120. Each cam member 126 includes a proximal end secured to the rotatable shaft of the drive motor 118 and a distal end that supports the finger 120. In this way, each finger 120 is supported by the corresponding cam member 126 such that the finger 120 is radially offset from the axis of rotation of the corresponding drive motor 118. In this configuration, the rotation of the cam member 126 causes the lateral position of the corresponding finger 120 to move toward or away from the center of the hand 110.

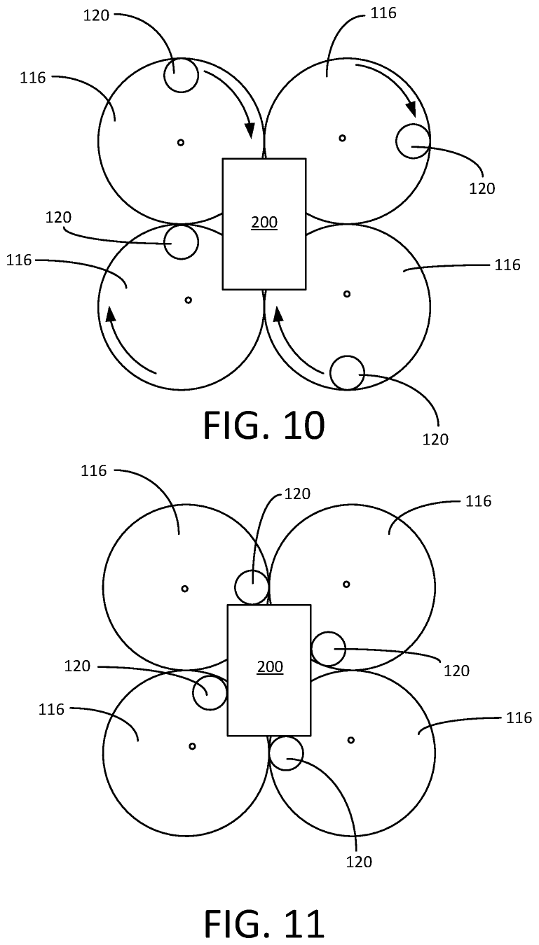

In other embodiments, the rotary carrier element 116 can be a disc or other platform that supports the finger 120 in a radially offset position from the rotational axis of the rotary carrier element 116 (discs are depicted in FIGS. 10-11). Although four rotary carrier elements 116 (cam members 126) are depicted, it will be appreciated that fewer or greater numbers of rotary carrier elements 116 are contemplated within exemplary embodiments. For example, in some embodiments, the hand 110 can include 2, 3, 4, 5, 6, 7, 8, 9 and 10 rotary carrier elements 116 that are each driven by a corresponding designated drive motor 118.

Unlike the first embodiment depicted in FIGS. 3-7, the hand 110 constructed in accordance with the second embodiment includes fingers 120 that are independently controllable by selectively actuating the designated drive motor 118. As best illustrated in FIGS. 10-11, the rotary carrier elements 116 are independently rotated in response to a control scheme and command signal from the control system 112 to approximate the fingers 120 around the object 200.

During use, the hand 110 can be used to grasp and move the object 200. To do so, the hand 110 is first positioned above the object 200, such that the object 200 is located within a grasping radius defined by the outer periphery of the fingers 120 on the rotary carrier elements 116. Each drive motor 118 then rotates the corresponding finger 120 into an “open” position in which the fingers 120 are located at a spaced-apart distance from the object 200. FIG. 10 depicts the fingers 120 in a suitable open position. In response to appropriate command signals, the drive motors 118 then rotate the rotary carrier elements 116 to approximate the fingers 120 toward the object 200, as depicted in FIG. 11. Because the rotary carrier elements 116 (e.g., cam members 126) are independently driven and controlled, the rotary carrier elements 116 can be rotated in different directions to approximate the fingers 120 around the object 200. The fingers 120 apply a clamping force to the object 200 that is sufficient to lift, move, tilt, or rotate the object 200. The extent of the clamping force applied by the fingers 120 to the object 200 can be controlled by monitoring the electrical current (load) on the drive motors 118. In other embodiments, separate force sensors can be used to detect the extent of lateral force applied by the fingers 200 to the object 200. To release the grip of the hand 110 on the object 200, one or more of the drive motors 118 rotate the rotary carrier elements 116 to move the fingers 120 away from the object 200, thereby releasing the grasp of the hand 110 on the object 200.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention.

The invention claimed is:

1. A robotic hand for use in grasping an object, wherein the hand comprises:
a base;
a plurality of rotary carrier elements;
a drive motor connected to at least one of the plurality of rotary carrier elements; and
a plurality of fingers, wherein each of the plurality of fingers is supported by a separate one of the rotary carrier elements.

2. The robotic hand of claim 1, wherein each of the plurality of rotary carrier elements has an axis of rotation about which the rotary carrier element rotates.

3. The robotic hand of claim 2, one or more of the plurality of fingers is attached to the corresponding rotary carrier element in a position that is radially offset from the axis of rotation of the rotary carrier element.

4. The robotic hand of claim 3, wherein each of the plurality of rotary carrier elements is a gear.

5. The robotic hand of claim 4, wherein the plurality of rotary carrier elements comprises:
a driven gear connected to the drive motor; and
a passive gear that is intermeshed with the driven gear.

6. The hand of claim 5, wherein the plurality of rotary carrier elements comprises a plurality of passive gears, wherein each of the plurality of passive gears is intermeshed with the driven gear.

7. The hand of claim 5, wherein the plurality of rotary carrier elements comprises a plurality of passive gears, wherein at least one of the plurality of passive gears is not intermeshed with the driven gear.

8. The hand of claim 1 wherein each of the plurality of fingers is rubber-coated.

9. The hand of claim 1, further comprising a plurality of drive motors, wherein each of the plurality of drive motors is connected to a separate one of the plurality of rotary carrier elements.

10. The hand of claim 9, wherein each of the plurality of rotary carrier elements is a cam member.

11. A robotic hand for use in grasping an object, wherein the hand comprises:
a base;
a plurality of rotary carrier elements, wherein the plurality of rotary carrier elements comprises:
a driven gear connected to the drive motor; and
a passive gear that is intermeshed with the driven gear;
a drive motor connected to at least one of the plurality of rotary carrier elements; and
a plurality of fingers, wherein each of the plurality of fingers is supported by a separate one of the rotary carrier elements.

12. The robotic hand of claim 11, wherein each of the plurality of rotary carrier elements has an axis of rotation about which the rotary carrier element rotates.

13. The robotic hand of claim 12, one or more of the plurality of fingers is attached to the corresponding rotary carrier element in a position that is radially offset from the axis of rotation of the rotary carrier element.

14. The robotic hand of claim 13, wherein each of the plurality of rotary carrier elements is a gear.

15. The hand of claim 5, wherein the plurality of rotary carrier elements comprises a plurality of passive gears, wherein each of the plurality of passive gears is intermeshed with the driven gear.

16. The hand of claim 5, wherein the plurality of rotary carrier elements comprises a plurality of passive gears, wherein at least one of the plurality of passive gears is not intermeshed with the driven gear.

17. The hand of claim 1 wherein each of the plurality of fingers is rubber-coated.

18. A robotic hand for use in grasping an object, wherein the hand comprises:
a base;
a plurality of rotary carrier elements;
plurality of drive motors is connected to a separate one of the plurality of rotary carrier elements; and
a plurality of fingers, wherein each of the plurality of fingers is supported by a separate one of the rotary carrier elements.

19. The hand of claim 18, wherein each of the plurality of rotary carrier elements is a cam member.

20. The hand of claim 8, wherein at least one of the plurality of fingers is curved.
